(19) United States
(12) Patent Application Publication
(10) Pub. No.: US 2008/0232691 A1
(43) Pub. Date: Sep. 25, 2008

(54) Method for Using Portable Electronic Equipment, Which Comprises a Digital Camera or Can be Connected to a Digital Camera, to Scan a Surface Containing Text and/or Drawings or Sketches

(76) Inventors: Karolos Gkikas, Glyfada (GR); Hao He, New South Wales (AU)

Correspondence Address: DAVIS BUJOLD & Daniels, P.L.L.C., 112 PLEASANT STREET, CONCORD, NH, 03301, US

(21) Appl. No.: 11/718,833

(22) PCT Filed: Oct. 18, 2005
(86) PCT No.: PCT/EP2005/011199

§ 371 Date: Jan. 24, 2008

(30) Foreign Application Priority Data
Nov. 8, 2004 (DE) 10 2004 054 131.0

(51) Int. Cl. G06K 9/46

(52) U.S. Cl. 382/190

(57) ABSTRACT

The invention relates to a method for using portable electronic equipment, which comprises a digital camera or can be used with a digital camera, to scan a surface containing text and/or drawings or sketches. According to the method, a digital photograph, which comprises the surface to be scanned, is taken with the digital camera of the electronic device. The text and/or drawings or sketches of the surface to be scanned are transferred to a digital image file, maintaining both their own and their mutual spatial arrangement. The effects that appear during the creation of the photograph comprising the surface to be scanned and that have a detrimental effect on the image, for example geometric distortion, lack of focus, blurring, shadows and/or light reflection effects, digital noise, lack of contrast and/or colorimetric shift, are removed or compensated.

This application is a national stage completion of PCT/EP2005/011199 filed Oct. 18, 2005 which claims priority from German Application Serial No. 10 2004 054 131.0 filed Nov. 8, 2004.

### FIELD OF THE INVENTION

The present invention concerns a method for using portable electronic equipment that comprises or can be connected to a digital camera, to scan a surface containing text and/or drawings or sketches.

In addition, the present invention relates to a system for the use of portable electronic equipment that comprises or can be connected to a digital camera, to scan a surface containing text and/or drawings or sketches, in particular to implement the method according to the invention.

### BACKGROUND OF THE INVENTION

Nowadays scanners or scanning devices are widely used. They serve to transform text and/or images, present on a surface, into a digital file. Scanning devices are usually used to digitize information contained on a sheet of paper. In this context, it is desirable to be able to transform not only what is on paper, but also the contents of panels, flip-charts, drawing boards, etc. into the form of a computer file.

For this purpose it is known from the prior art to use specialized equipment, such as the so-termed electronic panels or ‘active boards’. Disadvantageously, these devices are not portable but are set up in fixed positions and have to be connected to special control and data capture equipment, for example computers and the like. This restricts their utility; furthermore, the production and purchasing costs and the maintenance costs of such equipment are high, so their widespread use does not seem likely. Such equipment in most cases uses a special surface that enables detection of the drawings and/or text; in other embodiments the movement of the pen is registered by detecting the microwaves emitted by it. In both cases the technology used involves high costs.

### SUMMARY OF THE INVENTION

The purpose of this invention is to present a method and a system for the use of portable electronic equipment that comprises or can be connected to a digital camera, to scan a surface containing text and/or drawings or sketches, which avoids the aforesaid disadvantages of the prior art. In particular, it should be possible to implement the method using simple, commercially available portable electronic equipment, and to achieve high reception quality of the data scanned.

### DETAILED DESCRIPTION OF THE INVENTION

Accordingly, a method for using portable electronic equipment which comprises or can be connected to a digital camera, to scan a surface containing text and/or drawings or sketches is proposed, according to which a digital photograph of the surface to be scanned is taken with the digital camera of the electronic device, such that the text and/or drawings or sketches on the surface to be scanned are transferred to a digital image file while maintaining their own and their mutual spatial arrangement, and any effects that occur during the creation of the photograph of the scanned surface that affect the image adversely, including geometric distortion, lack of definition, blurring, shadows and/or light reflection effects, digital noise, lack of contrast and/or chromatic distortion, are removed or compensated.

According to the invention the method comprises the following steps:

a) a digital photograph of the surface to be scanned is taken using the digital camera of a portable electronic device;

b) the edges of the surface to be scanned are defined;

c) the background of the surface to be scanned is optionally defined, preferably as white, green or black;

d) the text and/or drawings or sketches in the surface scanned are transferred to a digital image file, and in this step any geometric distortion, lack of definition or blurring of the photographed image, shadow and/or light reflection effects, digital noise, lack of contract and/or chromatic distortion are corrected,

steps b), c) and/or d) being carried out in the electronic equipment on or in another device that can be connected to the portable equipment, which comprises a computer unit.

In doing this, the procedure for defining the surface to be scanned is as follows: intersecting straight lines next to the edges of the photograph are detected, the lines exhibiting strong contrast with the background surrounding the lines, and these lines are then proposed as the edge of the surface to be scanned. In the case when the photograph contains no such detectable lines, the edge of the photograph is proposed as the edge of the image to be scanned. According to the invention, the user can accept the proposed edge, or can input the edge of the image to be scanned manually.

According to the invention, to transform the image to be scanned into a digital image file, i.e. to carry out the actual scanning process, the procedure is as follows: it is assumed that the content of the image to be scanned consists of a quantity of coherent lines and differently colored areas. Accordingly, a pattern recognition process is applied in order to recognize these contained elements and distinguish them from the background. For this, coherent lines or colored areas are recognized and classified as separate objects, so that the area to be scanned consists of these objects in their own and their mutual spatial arrangement.

When the photograph of the image to be scanned is taken with the digital camera of the portable electronic equipment, the photograph may be affected adversely by a number of effects such as geometric distortion, lack of definition, blurring, shadow and/or light reflection effects, digital noise, lack of contrast and/or chromatic distortion. The method according to the invention enables such effects to be removed or compensated for in order to be able to obtain as exact a scanning result as possible.

Geometric distortion can be compensated by a geometric transformation of the contour of the objects contained on the surface scanned. For this, the parameters required for the transformation are obtained from the detection of at least two lines that cross one another at an angle of 90° in the original image. For example, this can be done by automatic detection of the outside edge of the photograph, for example the edges of a sheet of paper, or the user can define such an edge by manual input.

According to the invention any lack of definition or blurring of the photographed image to be scanned that results from possible tremors or movements when taking the photograph or from poor focusing of the digital camera, which often happens with portable equipment not designed for high-quality images, can be compensated for by the use of an inverse convolution function. For this purpose knowledge of the convolution function is needed, and is obtained by subjecting some differently sized portions of the image scanned to Fourier transformation, whereby an approximation of the convolution function is obtained, from which the inverse convolution function is calculated. This notion is based on the fact that independent of the spatial size of the image elements in Fourier space, the blurring of an image is described by a common expression or a common form. A possibility for the calculation of the inverse convolution function is based on the use of a Wiener filter. In addition, according to an advantageous further development of the invention it is provided that this step of compensating for lack of definition and blurring is carried out iteratively until a qualitatively good result is obtained. This procedure is different from the image stabilization method of the prior art.

According to the invention shadow and/or light reflection effects are compensated for under the assumption that the color quality of each separate object contained in the image to be scanned is uniform and that each variation in the photograph is the result of non-uniform illumination, so that such variations are detected and compensated for by calculating the inverse illumination function on the basis of the light distribution over the image, which is applied to the image as a whole. In typical application cases of the invention shadow and/or light reflection effects occur very often, since the text and/or drawings or sketches to be scanned are usually presented on a reflective white surface.

According to the invention the compensation for or removal of digital noise is based on the fact that the spectrum of digital noise is shaped differently from the spectrum of objects in the image scanned, so that the digital noise spectrum is detected, separated out and removed. Since many external factors influence digital noise, the noise is not uniformly distributed, so that, according to the invention an image-coordinate-dependent variable image analysis based on a local image statistic is carried out in order to optimize the efficacy of the process.

In addition, for the case of a lack of contrast in the photograph it is proposed to detect intensity variations and to transform areas of weak contrast with reference to a predetermined value into areas of high contrast.

According to the invention a possible chromatic distortion of the colors in the photograph or scanned image is compensated for by detecting the color properties of the photograph and then determining the optimal values of the color spectrum of the photograph, the color of each image element or pixel then being standardized or unified relative to these values. The color bands used are preferably green, red and blue.

The scanned image produced in this way is preferably displayed on a white background in order to enhance its readability. In cases when the original image background is black or green, light or white objects are shown in black.

Thanks to the concept according to the invention, an image taken with a portable device can be optimized or scanned and transformed into a digital file, which is comparable to a file scanned with a conventional scanner since a file produced by a conventional scanner comprises no geometric distortion, no lack of definition or blurring, no shadow and light reflection effects and no digital noise.

Thus, the method according to the invention enables the use of a conventional portable device that comprises or can be connected to a digital camera, for example via a plug-in module, to photograph and then scan the contents of a surface from any desired angle and from a not necessarily constant distance. Of course, the method according to the invention can also be used to transform an image defined from a fixed-position photography device into a digital file of optimum quality or readability.

The method is especially suited for portable equipment that comprises or can be connected to a digital camera, such as mobile telephones, PDAs, wrist-watches comprising a digital camera, portable electronic game devices or game consoles comprising a digital camera, etc. In addition the method according to the invention is also suitable for processing images taken with a digital camera by means of a device that comprises a computer unit, such as a PDA, a laptop or a PC.

The portable equipment can comprise a computer unit of its own to carry out all the steps of the method according to the invention. It is also possible however, for the software and hardware resources required for this to be separate components that can be connected or combined with the portable device, for example in the form of a plug-in card.

In accordance with a particularly advantageous variant of the method, the portable device is only used to take the photograph and this is stored intermediately; then, to carry out the further steps according to the invention the photograph is transmitted by conventional methods to a computer or to equipment that comprises a computer unit. Once the photograph has been processed, the finished image that corresponds to the scanned image can be sent back to the portable device, stored in the computer and/or sent to any other receiver or computer.

If the portable device has sufficient computing power, the user can either process the image in the portable device or transmit it by means of the device to another computer.

A portable device such as a mobile telephone can for example be used for scanning as follows: using the mobile telephone, a photograph is taken and stored in the mobile telephone. Then, the step of defining the edges of the surface scanned can be carried out with the mobile telephone with the option of manual intervention by the user, or the photograph is sent by conventional methods to another computer to establish the edges. When the edges have been defined by the computer, the user can confirm the edges chosen via a connection to that computer, or can determine the edges of the image scanned by manual intervention.

The transformation of the image or the actual scanning process is then carried out on the other computer, where the image prepared is also stored. This image can be sent to the mobile telephone or to any other receiver, and/or stored in the computer for later use.

The portable device and the other computer can be connected via an Internet connection protocol, via e-mail, SMS, MMS, GPRS, i-mode, UMTS, CDMA, WiFi, WiMax or other methods, which can also be combined with one another.

For example, when a mobile telephone or a device with a mobile telephone module is used to take the photograph of the surface to be scanned, the image produced can be transmitted to the other computer via MMS, UMTS, a Bluetooth or an Internet connection, and its storage location in the other computer notified to the user via an SMS on the mobile telephone. When a simple digital camera or game console is used to take the photograph, this can be connected to a computer to carry out the further steps of the method, for example via a Bluetooth or USB connection.

According to the invention the scanned image can be sent directly to a printer, and this can even be done by cordless means.

The method according to the invention can also be used to scan a surface comprising, besides text and/or drawings or sketches, also a surface comprising image contents, and for this purpose the steps of compensating weak contrast and/or chromatic distortion are not carried out or only partially so, and the background colors of the photograph are not changed.

In addition the method according to the invention can be used to “clean up” a darkened photograph of a surface comprising text and/or drawings or sketches, such as a poor fax copy or a file of poor quality scanned by by which the method is implemented.

1-22. (canceled)

23. A method of using portable electronic equipment, including a digital camera or communicating with the digital camera to scan a surface containing at least one of text, drawings and sketches, the method comprising the steps of:
taking a photograph, with the digital camera of the electronic equipment, of the surface to be scanned including at least one of the text, the drawings and the sketches of the surface to be scanned;
creating a digital image file of the photograph;
maintaining individual and mutual spatial arrangement of the at least one of the text, the drawings ans the sketches; and
one of removing and compensating for effects appearing during the production of the photograph comprising the surface to be scanned and having a detrimental effect on the image, including at least one of geometric distortion, lack of definition, blurring, shadow, light reflection effects, digital noise, lack of contrast, and chromatic distortion.

24. The method of using portable electronic equipment, including a digital camera or communicating with the digital camera to scan a surface containing at least one of text, drawings and sketches, according to claim 23, Further comprising at least one of the steps of defining either one of manually and automatically edges of the surface to be scanned before the digital image file is created from the photograph taken by the digital camera and defining a background color of the digital image file.

25. The method of using portable electronic equipment, including a digital camera or communicating with the digital camera to scan a surface containing at least one of text, drawings and sketches, according to claim 24, further comprising the step of storing the photograph taken by the digital camera in the electronic equipment, and if the electronic equipment comprises a computer unit, then at least one of defining edges of the surface to be scanned, defining a background color of the digital image file and one of removing and compensating for the effects that affect the image adversely, in one of the electronic equipment and other equipment that comprises a computer unit, whereas if the electronic equipment does not comprise a computer unit, then at least one of defining the edges of the surface to be scanned, defining the background color of the digital image file and one of removing and compensating for the effects that affect the image adversely, in other equipment that comprises a computer unit and, transmitting the photograph taken by the digital camera to the other equipment by one of a cordless and a cable-connected means.

26. The method of using portable electronic equipment, including a digital camera or communicating with the digital camera to scan a surface containing at least one of text, drawings and sketches, according to claim 25, further comprising at least one of the steps of transmitting the digital file image back to the portable unit by one of the cordless and the cable-connected means, storing the digital image file in the computer and sending the digital image file to any desired receiver or computer, if other equipment comprising a computer unit is used, the digital image file is transmitted back.

27. The method of using portable electronic equipment, including a digital camera or communicating with the digital camera to scan a surface containing at least one of text, drawings and sketches, according to claim 26, further comprising the steps of transmitting the photograph via one of a MMS, a Bluetooth and an Internet connection to the equipment that comprises a computer unit (computer) for one of removal and compensation for effects that affect the image adversely, when a mobile telephone or a unit with a mobile telephone is used to take the photograph, communicating a storage location of the digital image file, created in the computer via an SMS to one of the mobile telephone and the equipment, and defining at least one of the edges of the surface to be scanned and the background color of the digital image file, in one of the mobile telephone and the computer.

28. The method of using portable electronic equipment, including a digital camera or communicating with the digital camera to scan a surface containing at least one of text, drawings and sketches, according to claim 27, further comprising the step of transmitting the digital image file created in the computer to one of the mobile telephone and the equipment with a mobile telephone module via one of an MMS, a UMTS, a Bluetooth and an Internet connection.

29. The method of using portable electronic equipment, including a digital camera or communicating with the digital camera to scan a surface containing at least one of text, drawings and sketches, according to claim 26, further comprising the step of forming the connection between the equipment and the equipment comprising the computer unit with one of a CDMA, a WiFi and a WiMax connection, if the equipment for taking the photograph is not one of the mobile telephone and the unit with the mobile telephone module.

30. The method of using portable electronic equipment, including a digital camera or communicating with the digital camera to scan a surface containing at least one of text, drawings and sketches, according to claim 23, further comprising the step of detecting intersecting straight lines closest to edges of the photograph, that show strong contrast against a background surrounding those lines to define the edges of the surface to be scanned contained in the photograph taken by the digital camera, if straight lines closest to edges of the photograph are not detected in the photograph, then the edge of the photograph is defined as the edge of the image to be scanned.

31. The method of using portable electronic equipment, including a digital camera or communicating with the digital camera to scan a surface containing at least one of text, drawings and sketches, according to claim 30, further comprising one of the steps accepting the edges defined, and manually inputting a desired edge of the image to be scanned.

32. The method of using portable electronic equipment, including a digital camera or communicating with the digital camera to scan a surface containing at least one of text, drawings and sketches, according to claim 23, further comprising the step of compensating for any geometric distortion that occurs when the photograph of the surface to be scanned is taken by a geometric transformation of the contour of the objects contained on the surface to be scanned, parameters required for the geometric transformation being obtained by detecting at least two lines in the original image that cross one another at an angle of 90°.

33. The method of using portable electronic equipment, including a digital camera or communicating with the digital camera to scan a surface containing at least one of text, drawings and sketches, according to claim 23, further comprising the step of compensating for any lack of definition or blurring occurring when the photograph of the surface to be scanned is taken, by applying an inverse convolution function, the inverse convolution function being obtained from a convolution function calculated under an assumption that blurring of the digital image is described independently of a spatial size of the image elements in Fourier space by one of a common expression and a common form, such that the convolution function is obtained by evaluating a Fourier transformation of variously sized objects contained in the photograph.

34. The method of using portable electronic equipment, including a digital camera or communicating with the digital camera to scan a surface containing at least one of text, drawings and sketches, according to claim 33, further comprising the step of iteratively carrying out the calculation of the inverse convolution function.

35. The method of using portable electronic equipment, including a digital camera or communicating with the digital camera to scan a surface containing at least one of text, drawings and sketches, according to claim 23, further comprising the step of compensating for at least one of the shadow light reflection effects that occur when the photograph of the surface to be scanned is taken, on the assumption that a color quality of each separate object contained in the image to be scanned is uniform and any differences in the photograph are the result of non-uniform illumination, by calculating an inverse illumination function on the basis of the light distribution on the image, which is applied to the entire image.

36. The method of using portable electronic equipment, including a digital camera or communicating with the digital camera to scan a surface containing at least one of text, drawings and sketches, according to claim 23, further comprising the step of compensating for any lack of contrast that occurs when the photograph of the surface to be scanned is taken by detecting intensity differences and transforming areas of low contrast into areas of high contrast with reference to a predetermined value.

37. The method of using portable electronic equipment, including a digital camera or communicating with the digital camera to scan a surface containing at least one of text, drawings and sketches, according to claim 23, further comprising the step of compensating for any chromatic distortion of the colors in the photograph that occurs when the photograph of the surface to be scanned is taken by detecting color properties of the photograph and then determining optimum values of the photograph's color spectrum, color of each image element or pixel then being standardized or unified relative to the optimum values.

38. The method of using portable electronic equipment, including a digital camera or communicating with the digital camera to scan a surface containing at least one of text, drawings and sketches, according to claim 23, further comprising the step of detecting any digital noise occurring when the photograph of the surface to be scanned is taken on a basis of a different shape of a digital noise spectrum compared with a spectrum of the objects to be detected in the image to be scanned, separated out and removed, and carrying out an image-coordinate-dependent variable image analysis based on a local image statistic to optimize efficiency of this process.

39. A system for scanning a surface including at least one of text, drawings and sketches, by taking a photograph, with a digital camera related to electronic equipment, of the surface to be scanned including at least one of the text, the drawings and the sketches of the surface to be scanned; transferring the photograph to a digital image file; maintaining individual and mutual spatial arrangement of the at least one of the text, the drawings and the sketches; and one of removing and compensating for effects appearing during the production of the photograph comprising the surface to be scanned and having a detrimental effect on the image, including at least one of geometric distortion, lack of definition, blurring, shadow, light reflection effects, digital noise, lack of contrast, and chromatic distortion, the system comprising:
the electronic equipment including the digital camera or communicating with the digital camera;
a hardware component which is connectable to the portable electronic unit and which has at least one of computing power and storage capacity, if the portable unit does not have sufficient software and hardware resources.

40. The system for scanning a surface including at least one of text, drawings and sketches according to claim 39, wherein the electronic unit related to the digital camera and a computing unit, in particular a computer, are connectable by one of a cordless and a cable connection means and in which the digital image file is created.

41. The system for scanning a surface including at least one of text, drawings and sketches according to claim 40, wherein the portable unit connects to a mobile telephone module.

42. The system for scanning a surface including at least one of text, drawings and sketches according to claim 39, wherein the portable unit is a mobile telephone, a digital camera, a wrist-watch, a game console, a PDA or a notebook.

43. The method of using portable electronic equipment, including a digital camera or communicating with the digital camera to scan a surface containing at least one of text, drawings and sketches according to claim 23, further comprising the step of at most only partially compensating for at least one of the lack of contrast and the chromatic distortion and retaining background colors of the photograph.

44. A method of scanning a surface, containing at least one of text, drawings and sketches, with portable electronic equipment and a digital camera to, the method comprising the steps of:
photographing the surface, containing at least one of the text, the drawings and the sketches with the digital camera of the electronic equipment;
translating the photograph into a digital image,
maintaining a spatial arrangement of elements of the surface;
one of removing and compensating for detrimental effects, which appear in the digital image during photographing the surface, the detrimental effects including at least one of geometric distortion, lack of definition, blurring, shadows, light reflection effects, digital noise, lack of contrast and chromatic distortion: and
“cleaning up” a darkened digital image of the surface containing at least one of the text, the drawings and the sketches.
